(19) United States
(12) Patent Application Publication
(10) Pub. No.: US 2026/0245759 A1
(43) Pub. Date: Aug. 20, 2026

(54) RADIATION AND IMPACT-PROTECTED RADIOACTIVE WASTE CASK

(71) Applicant: GLOBAL TELE MARKETING GTM SA, Geneve (CH)

(72) Inventors: Mark KETTNER, Schriesheim (DE); Pierre DE LOËS, Vandoeuvres (CH)

(21) Appl. No.: 18/874,424

(22) PCT Filed: Mar. 6, 2023
(86) PCT No.: PCT/EP2023/055629

§ 371 Date: Dec. 12, 2024

(30) Foreign Application Priority Data
Jun. 20, 2022 (LU) 502 319

(51) Int. Cl. G21F 5/005; G21F 1/12; G21F 5/08; G21F 5/12

(52) U.S. Cl. CPC G21F 5/005; G21F 1/125; G21F 5/08; G21F 5/12

(57) ABSTRACT

A radiation and impact-protected radioactive waste cask, having a radioactive waste storage container defining an inner space with a radiation-protected cavity, including—stainless-steel inner and outer facing walls,—a layer of mild steel between the inner and outer walls,—a stainless-steel bottom,—a continuous lead lining covering the inner wall and the bottom on their side facing the inner space and separated from said the radiation-protected cavity by a beaker-shaped stainless-steel enclosure,—a stainless-steel top having a lead layer, the top configured for closing the radiation-protected cavity,—one or more inner radioactive waste vessels for containing radioactive waste and placed inside the radiation-protected cavity,—a volume of quartz sand at least partially filling up a space of the radiation-protected cavity left after insertion of the vessels, and—a stainless-steel lid attached to and sealingly closing the storage container

### CROSS-REFERENCE TO RELATED APPLICATIONS

This application is a 35 U.S.C. § 371 National Stage patent application of PCT/EP2023/055629, filed on 6 Mar. 2023, which claims the benefit of Luxembourg patent application 502 319, filed on 20 Jun. 2022, the disclosures of which are incorporated herein by reference in their entirety.

### TECHNICAL FIELD

The present disclosure generally relates to the field of safely transporting and storing long-lived radioactive waste. In particular, the present disclosure relates to a container for storing low-to-high activity long-lived radioactive waste with enhanced resistance to leakage due to mechanical stress.

### BACKGROUND

Containers for storing radioactive waste are known in the art. Their primary function is mostly to contain the nuclear waste in a way to allow for long-term or even ideally permanent storage in order to ensure the protection of humans and the environment for extended periods of time. A large number of solutions have been proposed reflecting the varying needs depending on the waste itself and the type of intended storage.

Indeed, while nuclear waste has different origins and characteristics, such as spent fuels from nuclear power plants, radioactive elements from medical or industrial use, or simply materials that have been in contact with radioactive elements, to date most of the waste cannot be recycled or reused.

Actually, the vast majority of the radioactive waste, i.e. about 90 %, is low activity short-lived radioactive waste, for which recycling does not seem practicable. The choice of managing these wastes has been made decades ago by setting up surface storage centers on an industrial scale.

The remaining 10 % of the radioactive waste is medium-to-high activity long-lived radioactive waste. While this waste is susceptible to some form of recycling, its storage in deep geological formations with the aim of developing underground storage devices and technologies has been debated for decades. Appropriate practical solutions are still discussed and a decision for long-term management of this type of nuclear waste has still to be taken. In the meantime, it is industrially stored on the surface in dedicated buildings for at least the next several decades, awaiting a solution for its more permanent and safer disposal.

Radioactive waste can be classified based on two criteria: radioactive activity and period of radioactive decay.

The radioactive activity of any radioactive material represents the number of nuclear disintegrations occurring per second and is measured in becquerels (1 Bq =1 disintegration per second).

Some examples of activity are as follows:
1 kg of rainwater: around 1 Bq (natural radioactivity),
1 kg of granitic soil: around 10⁴ Bq (natural radioactivity),
1 kg of uranium ore: around 10⁵ Bq (natural radioactivity), 1 kg of spent nuclear fuel just after discharging*: of the order of 10¹⁴ Bq.
*Activity decreases with time. After 10 years, nuclear fuel activity decreased by a factor of about 6.

The period of radioactive decay or, in short, their “period” or “half-life”, is by definition the time necessary for the radioactive activity of the material to drop to half its initial value. The half-life does not depend on the mass of material considered. Each pure radionuclide has a perfectly known period, its value can range from less than one thousandth of a second (e.g. polonium 214: 0.16 ms) to several billion years (e.g. uranium 238: 4.5 billion years) through all intermediate values (e.g. iodine 131: 5 days, cesium 137: 30 years, plutonium 239: 24 000 years, uranium 235: 7 million years, etc.). If different radionuclides are present, the longest of all radionuclide half-lives is taken as the value for the radioactive decay period. Furthermore, as an initially short-lived radionuclide may decay to produce longer life daughter nuclides, the half-life of the longest-lived daughter nuclide is used.

From two criteria, “activity” and “period”, the classification following the activity reflects the technical precautions that it is necessary to take in terms of radiation protection and the ranking according to the period reflects the duration of the potential harm.

Regarding the activity criterion, waste is said to have:
“very low activity” if its activity level is less than one hundred becquerels per gram (order of magnitude of natural radioactivity),
“low activity” if its activity level is between a few tens of becquerels per gram and a few hundred thousand becquerels per gram and its content in radionuclides is low enough not to require protection during normal handling and transport operations,
“medium activity” if its activity level is about one million to one billion becquerels per gram (1 MBq/g to 1 GBq/g),
“high activity” if its level of activity is of the order of several billion becquerels per gram (GB/g), the level for which the specific power is of the order of a watt per kilogram, hence the designation of “hot” waste.

Regarding the period criterion, waste is said to have:
a “very short life”, if its period is less than 100 days (which allows it to be managed by radioactive decay, to be treated after a few years as normal industrial waste),
a “short life”, if its radioactivity comes mainly from radionuclides that have a period of less than 31 years (which ensures its disappearance on a historical scale of a few centuries),
a “long life”, if it contains a large quantity of radionuclides with a period greater than 31 years (which requires containment and dilution management compatible with geological time scales).

In general, after ten times the half-life of a radionuclide, its activity has been divided by 1024, which enables it move from one activity category to another. So, after 310 years, “medium activity short-lived” waste becomes no more than “low activity short-lived”, and three additional centuries will make it fall into the “very low activity” category.

Other classification criteria involve chemical risks and the physicochemical nature of the waste. Radioisotopes will be all the more dangerous because they are highly radioactive, have chemical toxicity, and can easily transfer into the environment.

Radioactive waste that requires elaborate and specific protection measures is high activity long-lived (HALL waste). The activity of this waste is usually sufficient to cause burns if you stay exposed too long. HALL waste is mainly derived from spent fuels from nuclear power plants.

For convenience, and due to the seriousness of the consequences of high activity waste for humans, it could now become required, according to the precautionary principle, to base the radiation protection of this high activity waste on geological containment devices. This radioactive waste would be stored in a deep geological layer and in a permanent way. However, although its radioactivity remains significant for hundreds of thousands, even millions, of years, this would be the case without counting on the fact that this waste will be transformed over time into “low activity long-lived” waste no longer imposing this level of precaution. Moreover, nothing to date can guarantee the sealing of containers, whatever they are, as well as rock stability over such long periods. As a result, radioactivity would inevitably rise to the surface by uncontrollably contaminating vital elements (water, soil, etc.) over very large areas.

The alternative option of storing HALL waste “underground” i.e. at depths, for example, not exceeding 5 m underground, and in monitored locations, allows easy access to waste in the case of future recycling.

In any case, further risks must be considered.

One such risk is linked to the fact that radioactive waste is generally not stored where it is produced. This means that the waste must be transported from its initial location ideally directly to its final storage location, but more often the transport implies more than one stopover before the waste arrives at its destination. While transporting as such already encompasses risks, such as transport accidents, such as collisions, derailments and similar incidents, further threads are present, such as notably fire.

A still further risk, mainly during transportation, but also during temporary or even underground storage at reduced depths, is the potential attack by terrorists with the intention to cause or at least to accept a radioactive contamination of a more or less important area in the pursuit of their political aims. Again, resulting fires may have a further impact on the overall casualties.

While HALL radioactive waste, such as spent nuclear fuels, is generally transported within complex and highly secured so-called dry cask storage containers (e.g. CASTOR® or CONSTOR® containers), there still is a need for solutions for the far larger amounts of low to medium activity and/or short-lived radioactive waste.

WO 2018/185233 discloses for example containers for radioactive waste comprising a steel outer wall, a steel inner wall, a lead layer located between the two steel walls, a steel bottom, a steel lid, a volume of quartz sand located inside the container, at least one inner vessel/cassette/inner box coated encircled covered at least partially covered by the volume of quartz sand and radioactive waste located inside the container. Due among others to the particular configuration of the lead layer and the quartz sand layer, the temperature resistance and thus the integrity of the container in the event of a fire, even at very high temperatures, could be increased for an extended period of time. Yet, an enhanced protection against impacts, such as in the case of a collision during transport or even the impact resulting from explosions or armed attacks would be desirable.

### SUMMARY

The present disclosure therefore provides increasing the security of a radioactive waste container, more particularly to increase its resistance to mechanical damage of any type, but especially due to impacts especially during transport, in particular in preparation for its storage on the surface or underground.

To achieve this feature, the present disclosure proposes in a first aspect a radiation and impact-protected radioactive waste cask, comprising a radioactive waste storage container which defines an inner space with a cylindrical or polygonal cavity, comprising:
a stainless-steel outer wall facing outwards,
a stainless-steel inner wall facing the inner space,
a layer of mild steel between the inner and outer stainless-steel walls,
a stainless-steel bottom,
a continuous lead lining covering the stainless-steel inner wall and the stainless-steel bottom on their side facing the cylindrical or polygonal cavity and separated from said cavity by a beaker-shaped stainless-steel enclosure,
a stainless-steel top comprising a lead layer, said stainless-steel top being configured for sealingly closing said radiation-protected cylindrical or polygonal cavity (i.e. the space defined within the beaker-shaped stainless-steel enclosure),
one or more inner radioactive waste vessels configured for containing radioactive waste and placed inside said radiation-protected cylindrical or polygonal cavity,
a volume of quartz sand at least partially filling up a space of the radiation-protected cylindrical or polygonal cavity left after insertion of the one or more inner radioactive waste vessels, and
a stainless-steel lid being attached to and sealingly closing the radioactive waste storage container.

Prior solutions, such as the radioactive waste container disclosed in WO 2018/185233 offer reliable and long-time protection against radiation leakage, even in case of fire. However, such containers may not resist significant mechanical stresses acting from the outside, such as impacts in case of a drop from a certain elevation, in case of accident during transport, against explosions resulting e.g. from a nearby fire or even against intentional damage in case of armed attacks.

The inventors have now devised a way to dramatically increase the intrinsic resistance to mechanical stresses from the outside, such as explosions, accidental or intended mechanical shock, while keeping the level of advantageous properties against damage due to fire. The placement of a layer of mild steel between the inner and outer stainless-steel walls, dramatically improves the radioactive container's resistance to mechanical shocks and impact, such as a drop from a height of up to a few meters, a crash during transport or the burst of a close-by explosion.

A mild steel in the context of the present disclosure generally has a carbon content of between 0.05% and 0.29% maximum with a relatively high melting point of between 1450° C. to 1520° C. Mild steel has advantageous properties, such as a high tensile strength, high impact strength, good ductility and weldability and good malleability with cold-forming possibilities. However, mild steel does not have a high resistance to corrosion if unprotected. This is achieved in the present disclosure by the hermetic encapsulation between two stainless steel walls, which then provide for appropriate corrosion protection. Some appropriate mild steel grades are e.g. EN 1.0301 (equivalent grades: AISI 1008; C10; DC01) containing 0.1% carbon, 0.4% manganese and 0.4% silicon. It also contains small amounts of copper (Cu), nickel (Ni), chromium (Cr), aluminum (Al), and molybdenum (Mo); EN 1.1121 (equivalent grades: AISI 1010) containing 0.08% to 0.13% carbon. Manganese is present in the range of 0.3% to 0.6%; EN 1.0402 (equivalent grades: AISI 1020; C22) having a carbon content from 0.18% to 0.23% with a manganese content range of 0.3% to 0.6%.

The protection against radiation is provided by a continuous (one-piece) layer of lead covering both the inner stainless-steel wall and the stainless-steel bottom. This continuous layer can be obtained by placing inside the cavity a beaker or pot-shaped stainless-steel enclosure whose outer dimensions are smaller than the cavity formed by the inner wall and bottom such that it is located at a determined and uniform distance from the inner wall (e.g. by maintaining the enclosure at the predetermined position with a temporary attachment structure or by using discrete spacers placed at appropriate locations) and by pouring molten lead into the space formed between the inner wall, the bottom and the beaker-shaped enclosure. An advantage of this process of providing such a continuous lead lining is that potential radiation gaps at the contact area between the inner wall and the bottom is completely avoided. This continuous poured lead lining is further able to protect the outside even in case the temperatures inside the container rise above the melting point of lead, either due to the heat released as a result of radioactive decay inside the vessel(s) and/or the heat coming from the outside, such as in case of a fire.

Furthermore, in case the decay heat produced as an effect of radiation on materials due to the energy of the alpha, beta or gamma radiation being converted into the thermal movement of atoms, becomes very high, the volume of quartz sand and radioactive waste located inside the container will further enhance resistance to high temperatures and will ensure the integrity of the container even at very high temperatures.

Indeed, this enhanced heat resistance is due to the fact that when the heat inside the container rises, first the lead sandwiched between the inner stainless-steel wall and the beaker-shaped stainless-steel enclosure will absorb important amounts of heat until it is entirely molten, at about 327° C. If the temperature inside the container still rises, the volume of quartz sand filling up the space left in the cavity by the vessel(s), and which to that moment mainly had the function of maintaining the inner vessels in place and protecting them from shocks exerted on the container, will begin to melt at about 1300-1600° C. depending on the purity of the quartz sand, absorbing a further large quantity of heat energy. In this context, depending on the materials used for the vessels and the grade of stainless steel, it might be desired or necessary, to lower the melting point of the quartz sand to lower values, such as e.g. below that of some or all stainless steels used. In such cases, one or more fluxes can be added to the quartz sand, such as sodium carbonate, potassium carbonate, calcium oxide, etc.

The temperature of the layer of lead, respectively of sand, partly in fusion, partly in solid state, will not rise above their respective melting temperature, as long as there remains any of it in solid state. The boiling point of lead will represent a further temperature plateau at about 1700° C.

According to advantageous embodiments of the disclosure, the lead lining is of a thickness of between 25 mm and 50 mm. The minimal thickness of the volume of quartz sand between the vessel(s) and the inner side of the beaker-shaped stainless-steel enclosure preferably is at least 2 cm, more preferably at least 3 cm. The maximum thickness of the quartz sand volume is preferably less than 10 cm, more preferably less than 8 cm and in particular less than 6 cm.

According to an advantageous embodiment, the radioactive waste storage container comprises a pressure relief valve. The valve will allow for the evacuation of gases from the melting/boiling of the lead contained in the space between the stainless-steel inner wall and stainless-steel bottom and the beaker-shaped stainless-steel enclosure.

The one or more inner vessels may be made of stainless steel. The stainless-steel inner vessel will not melt until a melting temperature of 1535° C. It may contain e.g. low-level radioactive waste. According to another preferred embodiment, the inner vessel is made of ceramic (material), wherein said ceramic (material) can be selected from oxide ceramics, non-oxide ceramics and mixtures thereof, including so-called refractory materials, e.g. refractory concrete, refractory cement, refractory castable, etc. The ceramic inner vessel is very interesting for its resistance at a temperature of 1400° C. or above, or even above the melting temperature of stainless steel. The ceramic inner vessel may contain e.g. high-level radioactive waste. The performance of the vessels may be further improved with reinforcing fibers, among which steel fibers or superalloy fibers, some examples being austenitic nickel-chromium-based superalloys, e.g. Inconel Alloy 600, 625, X-750, etc.

The one or more inner vessels may comprise an attached cap and both the inner vessel and the cap are preferably made of optionally reinforced ceramic material as described above. Advantageously, the cap is attached to the vessel with removable clamps. Only the inner vessel(s) will contain the radioactive waste to physically isolate it from the remainder of the radioactive waste storage container. Advantageously, a layer of plastic material is provided on top of the radioactive waste inside the inner vessel(s) to act as a further sealant and desirable neutron catcher. Appropriate plastic materials may comprise materials, such as polyethylene (PE, e.g. LDPE, HDPE, UHMWPE, etc.) or thermoplastic natural rubber of high-density polyethylene/natural rubber (HDPE/NR) blends, preferably being borated/comprising boron carbide.

In particular when more than one vessel is to be stored in the radioactive waste storage container, it preferably contains an inner rack comprising a corresponding number of compartments, the one or more vessels being arranged in (the compartments of) said inner rack. The rack facilitates the arrangement of several vessels inside the radioactive waste storage container. As the space of the radiation-protected cylindrical or polygonal cavity left after insertion of the one or more inner radioactive waste vessels is later filled with a volume of quartz sand, the rack is provided with appropriate passages for the quartz sand to easily distribute within said space. As the rack does not need to significantly support the vessel(s) once the quartz sand has filled up the surrounding space, in particularly advantageous embodiments, the rack has a simple wire or mesh structure. The rack may comprise one or more rack positioning means and/or one or more gripping means for facilitating the correct placement of the rack inside the radiation-protected cylindrical or polygonal cavity, and/or one or more vessel centering means for facilitating the correct placement of the vessel(s).

The stainless steel of the inner and/or outer stainless-steel walls is preferably austenitic stainless steel, such as EN 1.4310, EN 1.4301, EN 1.4307, EN 1.4305, EN 1.4541, EN 1.4401, EN 1.4404 or EN 1.4571, preferably AISI 316L (AISI, American Iron and Steel Institute)/EN 1.4404 stainless steel. Alternatively, the stainless steel of the inner and/or outer stainless-steel walls may be martensitic stainless steel, such as EN 1.4006, EN 1.4021, EN 1.4116, EN 1.4104, EN 1.4122, EN 1.4125, EN 1.4057, EN 1.4418 or EN 1.4542, preferably AISI 410 or 420/EN 1.4021 stainless steel.

To further protect the radioactive waste storage container or the inner radioactive waste vessel (also called simply inner vessel), either or both may further comprise an outer envelope or an outer casing comprising or made of one or more layers of materials, such as rubber, plastic, silicone or mixtures thereof, at least partially covering the outer wall of the radioactive waste storage container and/or the wall of the inner vessel. Providing such an outer casing at least below the bottom and in their lower part advantageously reduces even the slightest slipping of the container during transport. Moreover, providing such an outer casing or envelope comprising or made of one or more layers of appropriate materials, such as polyethylene (PE, e.g. LDPE, HDPE, UHMWPE, etc.) or thermoplastic natural rubber of high-density polyethylene/natural rubber (HDPE/NR) blends (which may optionally be borated/comprise boron carbide), substantially on the whole outer surface of the inner radioactive waste vessel and/or of the radioactive waste storage container, may additionally act as a desirable neutron catcher.

To still further enhance the resistance to mechanical stress from the outside at least during transport or even until definitive storage, such as deep geological disposal, the radiation and impact-protected radioactive waste cask, advantageously (at least temporarily) further comprises a removable outer transportation canister, wherein the removable outer transportation canister comprises a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover are made of at least three layers, an outer layer made of armor grade steel, preferably having a thickness of at least 15 mm, an inner layer made of high strength steel, preferably having a thickness of at least 35 mm, and an intermediate layer between said outer and inner layers, preferably having a thickness of at least 25 mm, said intermediate layer being made of one or more strati comprising or consisting of ceramic material, wherein said ceramic material is selected from oxide ceramics, non-oxide ceramics and mixtures thereof, including so-called refractory materials, e.g. refractory concrete, refractory cement, refractory castable, etc.

To facilitate the correct placement of the radioactive waste storage container within the removable outer transportation canister, the bottom of the removable outer transportation canister may comprise positioning blocks. Advantageously said positioning blocks have a tapered shape opening to their upper side so as to self-center the radioactive waste storage container when it is lowered into place. These positioning blocks may also provide for holding in place the radioactive waste storage container once it is fully inserted into the transportation canister. Similar centering blocks may be provided at appropriate locations on the inner side of the canister's hollow cylindrical or polygonal body or alternatively on the outer circumference of the radioactive waste storage container. Alternatively or additionally, the removable outer transportation canister may further comprise an inner and/or outer covering comprising or made of materials such as those described above for the optional outer envelope of the radioactive waste storage container.

In preferred embodiments, the radioactive waste storage container can be further secured by at least partially, preferably entirely, filling up any void within the hollow cylindrical or polygonal body of the removable outer transportation canister and radioactive waste storage container with quartz sand. This volume of quartz sand does not only help in avoiding any movement of the radioactive waste storage container during transport, but further enhances the resistance to mechanical stresses and its resistance to fire.

Armor grade steels (also sometimes called military grade steels or ballistic steels), that can be used for the outer layer of the outer transportation canister, generally have a maximum carbon contents by weight of 0.32%. However, the focus is clearly on their hardness. Simply defined, their hardness, represented by the Brinell Hardness, is calculated by comparing the amount of applied force on a piece of material to the size of the indentation of the force. More specifically, the Brinell hardness test consists of applying a constant load, usually in the range 500-3000 N, for a specified period of time (10-30 s) using e.g. a 5 or 10 mm diameter hardened steel or tungsten carbide ball on the flat surface of a work piece. According to ISO 6506-1:2014, the Brinell hardness (HBW, using a tungsten carbide ball) expressed in MPa is then obtained as:

$${HBW = 0.102 * 2 F / \{ Π D [ {D}^{2} - {d}^{2} )}^{1 / 2} ] \}$$

where D is the ball diameter (mm), d is the diameter of the resultant, recovered circular indentation (mm) and P is the applied load (kg). Hence, the HB is obtained by dividing the applied load by the surface area of the indentation and not the projected area.

The armor grade steel for the outer layer of the outer transportation canister preferably has a Brinell Hardness, HBW, of at least 3900 MPa according to ISO 6506-1:2014. Appropriate armor grade steels are e.g. A36, AR400, A500, MIL-46100, MIL-12560 or MIL-46177. While the outer layer is preferably made of one sheet of appropriate thickness, it may comprise two or more superposed (thinner) armor grade steel sheets, if deemed necessary or desirable.

The high strength steel of the inner layer generally has a Brinell Hardness, HBW, of between 2450 and 3675 MPa according to ISO 6506-1:2014. Appropriate high strength steels are generally steels having a yield strength ranging between 210-550 MPa and a tensile strength between 270 to 700 MPa. In the context of the disclosure, the term “high strength steel” thus includes steels with yield levels higher than 550 MPa which are generally designated advanced high strength steels, and which when their tensile strength levels exceed 780 MPa, are usually referred to as ultra-high strength steels. Again, while the inner layer is preferably made of one thick sheet, it may comprise two or more thinner, superposed high strength steel sheets if deemed necessary or desirable.

The intermediate layer may comprise two or more strati, each comprising or consisting of ceramic material, wherein said ceramic (material) can be selected from oxide ceramics, non-oxide ceramics and mixtures thereof, including so-called refractory materials, e.g. refractory concrete, refractory cement, refractory castable, etc., such as in particular alumina, boron carbide, and/or silicon carbide, with a backing of a ductile fiber reinforced layer or a metal leaf, most preferably the ductile fibers are weaved para-aramid fibers, such as poly-(para-phenylene terephthalamide), e.g. Kevlar®, Twaron®, etc. Kevlar® K-29, K49, K119, K129, K149, AP, XP or KM2, or combinations thereof are examples of appropriate para-aramid fibers. If the backing(s) within the intermediate layer is/are metal leaves, they may be made of similar materials as the outer or the inner layer, i.e. armor grade steel, high strength steel or even a mild steel grade as used for the radioactive waste storage container. In case of two or more strati, these are preferably positioned such that any joints between adjoining element within one stratum are placed in a staggered fashion with any element of the below or above strati.

In view of the need for safely containing, transporting and storing radioactive waste despite the risks associated therewith, be they linked to the very nature of the contents of the inner radioactive waste vessel(s) or to extraneous factors directly related to transport or even the risk from deliberate attacks, it is desirable to provide the radiation and impact-protected radioactive waste cask, such as the radioactive waste storage container and/or the outer (radioactive waste) transportation canister with an autonomous (e.g. battery backed) monitoring and/or transmission device, which is configured for recording and/or transmitting (on request, change or schedule) identification and physical data about the radioactive waste storage container and/or the outer transportation canister, such as its/their identity, integrity, location, movement, inside and/or outside temperature, humidity and/or pressure, etc. using appropriate sensors, such as GPS tracker, motion detectors, temperature, humidity and/or pressure sensors, etc. Unauthorized tempering may be detected for example through unscheduled movement, unexpected humidity, pressure and/or temperature changes outside or within the radioactive waste storage container and/or the outer transportation canister, etc. Hence, it might also be advantageous that the transmission device is configured to actively transmit an appropriate alarm when the radiation and impact-protected radioactive waste cask is unexpectedly moved and/or tempered with, by providing information such as identity, integrity, location, movement, etc. in order to allow for rapid intervention and safeguarding measures to be taken. In embodiments, the monitoring and/or transmission device of the outer transportation canister may be configured to (also) relay to the corresponding data and/or to (also) amplify the signal from the radioactive waste storage container contained therein.

A further aspect of the disclosure is the use of an outer transportation canister for further temporary protection of a radioactive waste storage container, preferably a radioactive waste storage container as defined herein or a container for radioactive waste as disclosed and claimed in WO 2018/185233 A1, from mechanical damage during transport and storage, such as impacts in case of a drop from a certain elevation, in case of accident during transport, against explosions resulting e.g. from a nearby fire or even against intentional damage in case of armed attacks, etc., thereby providing a radiation and impact-protected radioactive waste cask, wherein the outer transportation canister comprises a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover are made of at least three layers, an outer layer made of armor grade steel, preferably having a thickness of at least 15 mm, an inner layer made of high strength steel, preferably having a thickness of at least 35 mm, and an intermediate layer between said outer and inner layers, preferably having a thickness of at least 25 mm, wherein said intermediate layer is made of one or more strati comprising or consisting of ceramic material, wherein said ceramic material is selected from oxide ceramics, non-oxide ceramics and mixtures thereof, including so-called refractory materials, e.g. refractory concrete, refractory cement, refractory castable, etc.

The present disclosure also describes, in a still further aspect, a method for further temporary protection of a radioactive waste storage container, preferably a radioactive waste storage container as defined herein or a container for radioactive waste as disclosed and claimed in WO 2018/185233 A1, from mechanical damage during transport and storage, such as impacts in case of a drop from a certain elevation, in case of accident during transport, against explosions resulting e.g. from a nearby fire or even against intentional damage in case of armed attacks, etc., thereby providing a radiation and impact-protected radioactive waste cask, the method comprising the provision of an outer transportation canister comprising a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover are made of at least three layers, an outer layer made of armor grade steel, preferably having a thickness of at least 15 mm, an inner layer made of high strength steel, preferably having a thickness of at least 35 mm, and an intermediate layer between said outer and inner layers, preferably having a thickness of at least 25 mm, wherein said intermediate layer is made of one or more strati comprising or consisting of ceramic material, wherein said ceramic material is selected from oxide ceramics, non-oxide ceramics and mixtures thereof, including so-called refractory materials, e.g. refractory concrete, refractory cement, refractory castable, etc.; placing the radioactive waste storage container inside said radioactive waste transportation canister, optionally filling up any void left within the radioactive waste transportation canister with quartz sand, and sealing the radioactive waste transportation canister by firmly closing the canister cover.

As the radioactive waste transportation canister will primarily be used during transport or even during temporary storage in facilities at the ground or at reduced depth below the ground, i.e. while the risk of mechanical stress cannot be ruled out, a still further aspect of the disclosure is a kit-of-parts comprising a first number of radioactive waste storage containers as described herein and a second number of outer transportation canisters as disclosed herein, wherein the first number is greater than the second number. Indeed, when the radiation and impact-protected radioactive waste casks including outer radioactive waste transportation canisters arrive at their final destination, such as in a deep geological disposal location, the radioactive waste storage containers can be removed from the radioactive waste transportation canister and stored and their radioactive waste transportation canisters can be reused for safely transporting further radioactive waste transportation canisters.

### BRIEF DESCRIPTION OF THE DRAWINGS

Preferred embodiments of the disclosure will now be described, by way of example, with reference to the accompanying drawings in which:

FIG. 1 is a schematic cross-sectional view of a first preferred embodiment of a radiation and impact-protected radioactive waste cask, comprising a radioactive waste storage container 10 and a removable outer transportation canister 200; and

FIG. 2 is a schematic cross-sectional view of a second preferred embodiment of a radiation and impact-protected radioactive waste cask, comprising a radioactive waste storage container 100 and a removable outer transportation canister 200.

Further details and advantages of the present disclosure will be apparent from the following detailed description of several not limiting embodiments with reference to the attached drawings.

### DETAILED DESCRIPTION OF THE DRAWINGS

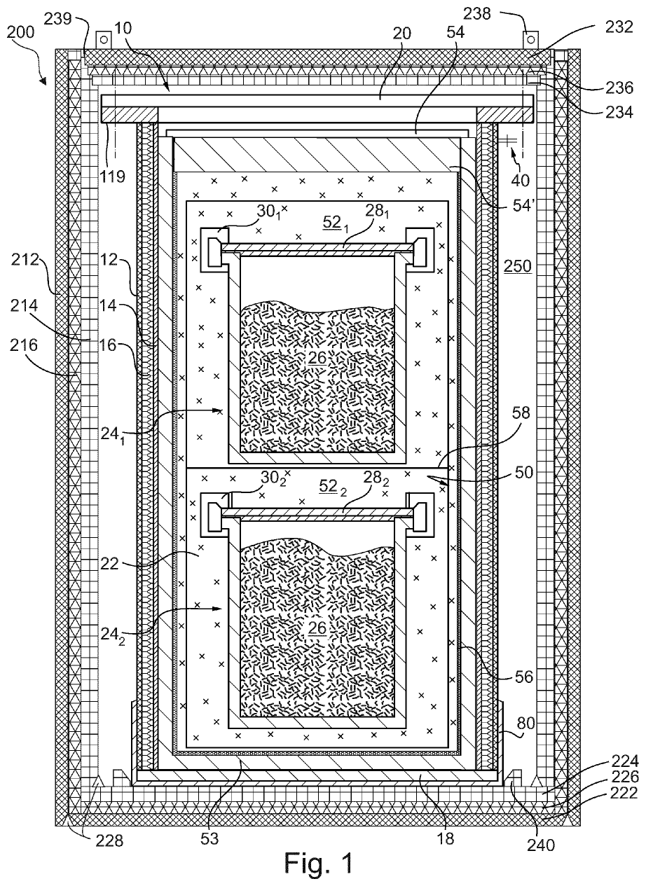

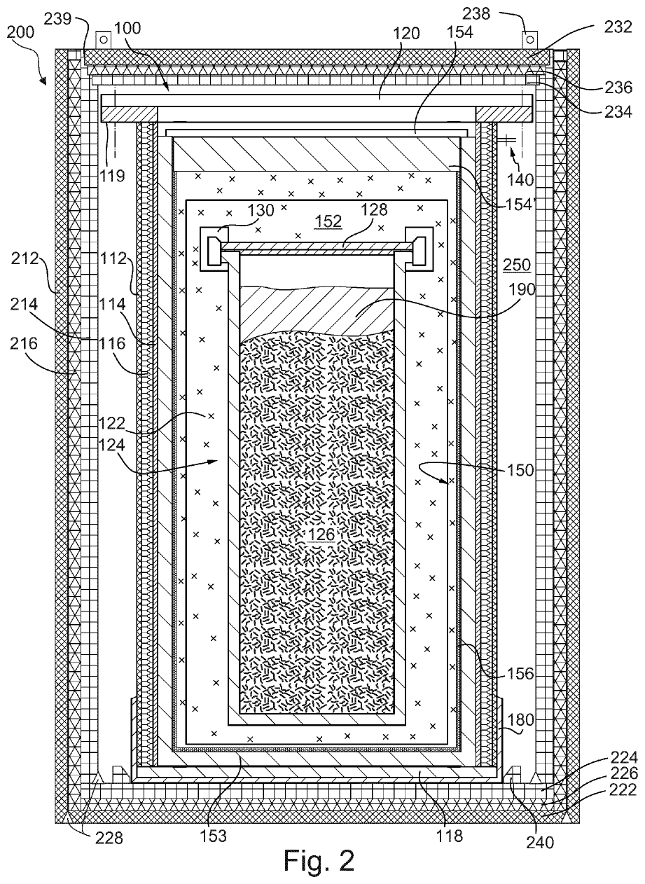

FIGS. 1 and 2 illustrate preferred embodiments radiation and impact-protected radioactive waste cask comprising a radioactive waste storage container 10, 100 further temporarily protected with a removable outer transportation canister 200.

In FIG. 1, a radioactive waste storage container 10 according to a first embodiment of the disclosure comprises a stainless-steel outer wall 12, a stainless-steel inner wall 14, a layer of mild steel 16 contained between the two stainless-steel walls 12 and 14, a stainless-steel bottom 18, a stainless-steel lid 20, a continuous lead lining 53 poured in the molten state between the stainless-steel inner wall 14, the stainless-steel bottom 18 and beaker-shaped stainless-steel enclosure 56, a stainless-steel top 54 with a lead layer 54′, a volume of quartz sand 22 located inside beaker-shaped stainless-steel enclosure 56 and at least one inner vessel 241 and 242 (represented by crosses in FIGS. 1 and 2). The radioactive waste 26 is located inside the vessel 24.

The beaker-shaped stainless-steel enclosure 56 and stainless-steel top 54 comprising a lead layer 54′, preferably enclosed inside a double-walled stainless-steel top 54, define an interior enclosure in which the vessels 241 and 242 with the waste 26 are housed and further held in place by the volume of quartz sand 22.

The radioactive waste storage container 10 preferably has a circular cross-section. Alternatively, it can have an oval, square or any polygonal shape. The stainless-steel inner and outer walls 12 and 14 with the sandwiched layer of mild steel 16 may be made, for example, by welding two stainless-steel sheets and one layer of mild steel placed in-between, said sheets having been appropriately rounded beforehand. The combined stainless-steel inner and outer walls 12 and 14 with their layer of mild steel 16 are welded at their lower edge to the stainless-steel bottom 18, which may also be made of the same three layers as the body of the radioactive waste storage container. The beaker-shaped stainless-steel enclosure 56 is then placed within the inner space with a radiation-protected cylindrical or polygonal cavity at a distance to the stainless-steel inner wall 14 and the stainless-steel bottom 18. This can be done by appropriately holding the beaker-shaped stainless-steel enclosure 56 in place with an external means (not shown) or by providing a discrete number of (lead) spacers (not shown). Molten lead or lead alloy is then poured between the inner wall 14 and the beaker-shaped stainless-steel enclosure 56 to form a continuous lead lining 16. Hence, even in case of fusion, the lead layer 16 does not spread inside the container. Moreover, the stainless-steel bottom 18 may be flat or include particular shapes, for example for the positioning of the vessels 241 and 242 or the rack 50.

Generally, the outer wall is of circular section with an outer diameter between 500 mm and 2000 mm. The container usually has a useful inner height, measured between the bottom of the beaker-shaped stainless-steel enclosure 56 and the inner side of the stainless-steel top, of between 800 mm and 5000 mm. Such sizes are generally advantageous because they are easily compatible with conventional cargo transport in terms of size and permitted weight. Outer walls with circular section generally offer best performance against both external and internal forces due e.g. to mechanical shocks and impact. Of course, it is clear that other dimensions, shapes and overall weights are also within the scope of the present disclosure.

The inner and outer walls 12 and 14 generally are of a thickness of between 3 mm and 10 mm and the layer of mild steel 16 may have a thickness of between 10 mm and 50 mm. The thickness of the wall of the beaker-shaped stainless-steel enclosure 56 may be less than that of the inner and outer walls 12 and 14 such as from 1,5 mm and 5 mm. The continuous lead lining 53 may have a thickness of between 25 mm and 50 mm. The stainless-steel bottom 18 and the stainless-steel lid 20 may be of a thickness equal to more than twice, for example three times the value of the thickness of the inner and outer walls 12 and 14.

The container 10 comprises a circular ring 19 attached to the upper end of the outer and inner walls 12 and 14 for fixing and sealingly closing the stainless-steel lid 20. The fixing ring 19 comprises holes for receiving bolts for fixing the lid 20 passing through corresponding holes in the stainless-steel lid 20.

Quartz sand means silica sand with traces of different elements such as Al, Li, B, Fe, Mg, Ca, Ti, Rb, Na, OH. Quartz sand has the property of vitrifying after melting then hardening. Quartz sand with a low melting point will be chosen, or appropriate fluxes are added. The volume of glass thus formed can also block some of the radioactive radiation (for example with a premix of the quartz sand with a radiation absorbing material).

The radioactive waste storage container 10 comprises a pressure relief valve 40, e.g. for evacuating gases emitted in case the lead lining 16 melts.

The container 10 further comprises a rack 50 comprising one or more superimposed compartments 52₁ and 52₂ receiving the two vessels 24₁ and 24₂. The rack 50 is preferably made of a wire or mesh structure in order not to impede the later filling-up with quartz sand. The inner rack 50 is made of stainless steel.

The inner vessels 24₁ and 24₂ include a removable cap 28₁ and 28₂ as well as means for securing/flanging/clipping/screwing 30₁ and 30₂ from the removable cap to the vessel 24₁ and 24₂.

The inner vessels 24₁ and 24₂ comprise centering means and/or one or more means for gripping/hooking/affixing eyelets (not shown).

In this first mode of realization, the container 10 comprises two ceramic inner vessels 24₁ and 24₂, preferably made of ACA 997 type ceramic, more preferably of special ceramic ACS 99,8LS 172. The vessel 24₁ and 24₂ with its cap 28₁ and 28₂ has a height of between 250 mm and 300 mm. The vessel 24₁ and 24₂ has a capacity of between 10 L and 20 L and withstands temperatures up to 1400° C.

The waste 26 placed in the vessel 24₁ and 24₂ is highly radioactive. In particular, this embodiment is intended for the storage of long-lived medium-to-high level radioactive waste, and in particular the non-recoverable final waste containing fission products and minor actinides, nuclear fuel ash.

Moreover, the container 10 preferably also comprises an outer rubber/plastic/silicone envelope 80 covering the outer wall 12. The outer rubber/plastic/silicone envelope 80 is only partially shown on the image at the lower zone of the container 10. The outer rubber/plastic/silicone envelope 80 is made by dipping the container 10 into a corresponding liquid/liquefied rubber/plastic/silicone bath. The outer envelope 80 will further prevent degradation of the container by water and prevent slipping of the radioactive waste storage container. Advantageously, an outer rubber/plastic envelope, such as an outer (high-density, HD) polyethylene (PE) envelope or an outer envelope comprising or consisting of thermoplastic natural rubber of high-density polyethylene/natural rubber (HDPE/NR) blend, optionally comprising boron carbide, may additionally act as neutron catcher.

FIG. 1 also shows an outer radioactive waste transportation canister 200 wherein the radioactive waste storage container 10 can be placed to further protect it from mechanical damage, especially during transport or against armed attacks. The radioactive waste transportation canister 200 comprises a body, a bottom and a cover, all comprising three layers, an outer layer 212, 222, 232, an inner layer 214, 224, 234 and an intermediate layer 216, 226, 236, wherein the outer layer 212, 222, 232 is made of armor grade steel, the inner layer 214, 224, 234 is made of high strength steel and an intermediate layer 216, 226, 236 is ceramic containing material, preferably composed of two or more strati, each comprising or consisting of ceramic material with a backing of a ductile fiber reinforced layer or a metal leaf, most preferably the ductile fibers are weaved para-aramid fibers. The respective steels are welded together as shown e.g. by welds 228 (other required welds are not necessarily shown).

The canister cover and the upper inner circumference of the canister body preferably are provided with complementary thread means 239 to allow for a sealing closure of the canister cover on the canister body. The canister cover or the canister body may be provided with means to facilitate, such as eyelets 238, closing the cover or transporting the whole radiation and impact-protected radioactive waste cask.

Advantageously, the inner dimension and shape of the radioactive waste transportation canister 200 are adapted to fittingly receive and hold in place the radioactive waste storage container 10 once it has been fully inserted. It might however be desirable to provide positioning blocks 240 (or similar) on the bottom (or the sides) of the radioactive waste transportation canister 200 not only to facilitate the correct positioning, but also to hold the container 10 in place after insertion.

The void 250 may be filled up, entirely or in part with quartz sand to further enhance the resistance of the radiation and impact-protected radioactive waste cask against mechanical damage.

FIG. 2 illustrates a second embodiment of a radiation and impact-protected radioactive waste cask with a radioactive waste storage container 100 and a radioactive waste transportation canister 200 similar to those represented in FIG. 1. In fact, common features of the radioactive waste storage canister will have reference numbers being increased by 100 with respect to the same or corresponding feature in FIG. 1. Reference numbers relating to the radioactive waste transportation canister 200 are the same as in FIG. 1.

In this second embodiment, the container comprises a single inner vessel 124. The inner vessel 124 is placed in a single compartment 152 of the inner rack 150. The inner vessel 124 is made of stainless steel. The inner vessel 124 with its cap 128 has a height of between 500 mm and 1000 mm and a capacity of between 50 L and 350 L.

The waste 126 shown in the inner vessel 124 is lightly radioactive. For example, the waste constitutes metal structures of fuel elements, resulting from the operation of the reactor, used gloves, protective suits, irradiated tools, shells, connectors, radioactive mining residues that may pose problems of chemical toxicity if uranium is present with other otherwise toxic products such as lead, arsenic, mercury etc., the radioactive waste of the medical sector and whose half-life is less than 100 days.

In the embodiment of the disclosure presented here, the container 100 also comprises a plastic layer 190, preferably a low-density or high-density polymer, covering the radioactive waste in the inner vessel 124. The plastic can be liquefied beforehand and mixed with a load and/or come from several low/high density polymers. Appropriate plastic materials may comprise materials, such as polyethylene (PE, e.g. LDPE, HDPE, UHMWPE, etc.) or thermoplastic natural rubber of high-density polyethylene/natural rubber (HDPE/NR) blends, preferably borated or boron carbide comprising materials.

1. A radiation and impact-protected radioactive waste cask, comprising a radioactive waste storage container which defines an inner space with a radiation-protected cylindrical or polygonal cavity, comprising:
a stainless-steel outer wall facing outwards,
a stainless-steel inner wall facing the inner space,
a layer of mild steel between the inner and outer stainless-steel walls,
a stainless-steel bottom,
a continuous lead lining covering the stainless-steel inner wall and the stainless-steel bottom on their side facing the inner space and separated from said radiation-protected cylindrical or polygonal cavity by a beaker-shaped stainless-steel enclosure,
a stainless-steel top comprising a lead layer, said stainless-steel top being configured for closing said radiation-protected cylindrical or polygonal cavity,
one or more inner radioactive waste vessels configured for containing radioactive waste and placed inside said radiation-protected cylindrical or polygonal cavity,
a volume of quartz sand at least partially filling up a space of the radiation-protected cylindrical or polygonal cavity left after insertion of the one or more inner radioactive waste vessels, and
a stainless-steel lid being attached to and sealingly closing the radioactive waste storage container.

2. The radiation and impact-protected radioactive waste cask according to claim 1, wherein the radioactive waste storage container comprises a pressure relief valve.

3. The radiation and impact-protected radioactive waste cask according to claim 1, wherein the one or more inner vessels comprise an attached removable cap and both the inner vessel and the cap are made of ceramic, wherein the cap is attached to the vessel with removable clamps.

4. The radiation and impact-protected radioactive waste cask according to claim 1, containing an inner rack comprising one or more rack compartments, the one or more vessels being arranged in the said inner rack.

5. The radiation and impact-protected radioactive waste cask according to claim 1, wherein the stainless steel of the inner and/or outer walls is austenitic stainless steel, or martensitic stainless steel.

6. The radiation and impact-protected radioactive waste cask according to claim 1, further comprising a rubber outer casing covering at least part of the stainless-steel outer wall of the radioactive waste storage container.

7. The radiation and impact-protected radioactive waste cask according to claim 1, further comprising a removable outer transportation canister, wherein the removable outer transportation canister comprises a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover are made of at least three layers, an outer layer made of armor grade steel, having a thickness of at least 15 mm, an inner layer made of high strength steel, having a thickness of at least 35 mm, and an intermediate layer between said outer and inner layers, having a thickness of at least 25 mm, said intermediate layer being made of one or more strati comprising ceramic material, wherein said ceramic material is selected from oxide ceramics, non-oxide ceramics and mixtures thereof.

8. The radiation and impact-protected radioactive waste cask according to claim 7, wherein any void within the hollow cylindrical or polygonal body of the removable outer transportation canister and radioactive waste storage container is at least partially filled up with quartz sand.

9. The radiation and impact-protected radioactive waste cask according to claim 7, wherein the armor grade steel of the outer layer has a Brinell Hardness, HBW, of at least 3900 MPa according to ISO 6506-1:2014.

10. The radiation and impact-protected radioactive waste cask according to claim 7, wherein the high strength steel of the inner layer has a Brinell Hardness, HBW, of between 2450 and 3675 MPa according to ISO 6506-1:2014.

11. The radiation and impact-protected radioactive waste cask according to claim 7, wherein the intermediate layer comprises two or more strati comprising ceramic material with a backing of a ductile fiber reinforced layer or a metal layer, wherein the ductile fibers are para-aramid fibers.

12. Use of an outer radioactive waste transportation canister for further temporary protection of a radioactive waste storage container as defined in claim 1, from mechanical damage during transport and storage, in particular from impact damage due to accident or projectiles, wherein the radioactive waste transportation canister comprises a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover being made of at least three layers, an outer layer made of armor grade steel having a thickness of at least 15 mm, an inner layer made of high strength steel having a thickness of at least 35 mm and an intermediate layer between said outer and inner layers, having a thickness of at least 25 mm, said intermediate layer being made of one or more strati comprising ceramic material, wherein said ceramic material is selected from oxide ceramics, non-oxide ceramics and mixtures thereof.

13. A method for further temporary protection of a radioactive waste storage container as defined in claim 1, from mechanical damage during transport and storage, thereby providing a radiation and impact-protected radioactive waste cask, the method including the following steps:
providing an outer transportation canister comprising a hollow cylindrical or polygonal body with a lower end and an upper end, configured for fittingly receiving therein the radioactive waste storage container, wherein the lower end is closed by a fixed bottom and the upper is closed with a removable canister cover, wherein the hollow cylindrical or polygonal body, the fixed bottom and the removable canister cover are made of at least three layers, an outer layer made of armor grade steel, preferably having a thickness of at least 15 mm, an inner layer made of high strength steel, preferably having a thickness of at least 35 mm, and an intermediate layer between said outer and inner layers, having a thickness of at least 25 mm, wherein said intermediate layer is made of one or more strati comprising ceramic material, wherein said ceramic material is selected from oxide ceramics, non-oxide ceramics and mixtures thereof;
placing the radioactive waste storage container inside said radioactive waste transportation canister,
optionally filling up any void left within the radioactive waste transportation canister with quartz sand, and
sealing the radioactive waste transportation canister by firmly closing the canister cover.
